(19) United States
(12) Patent Application Publication
(10) Pub. No.: US 2012/0011134 A1
(43) Pub. Date: Jan. 12, 2012

(54) SYSTEMS AND METHODS FOR DATABASE QUERY TRANSLATION

(76) Inventors: Jakub TRAVNIK, Prague (CZ); Petr Smid, Bmo (CZ); Vladimir Dubsky, Podebrady (CZ)

(21) Appl. No.: 12/832,574

(22) Filed: Jul. 8, 2010

(51) Int. Cl. G06F 17/30

(52) U.S. Cl. 707/756; 707/760; 707/E17.07; 707/E17.044

(57) ABSTRACT

In at least some embodiments, a system includes a client layer having a client computer with a database query interface. The system also includes a database layer having a relational database and an object model database. The system also includes an application layer in communication with the client layer and the database layer. The application layer is configured to receive an object form query from the database query interface, translate the object form query to a structured query language (SQL) query, and forward the SQL query to the relational database. The object form query comprises an object, object property criteria, and object history criteria.

### BACKGROUND

Data in a database can be organized in many different ways. In order to query a database, a querying language may be implemented. As an example, the structured query language (SQL) can be used to query a relational database. However, if a user is inexperienced with SQL and/or does not understand the underlying database organization, performing a query is difficult or ineffective. Further, the organization of a database may be changed or updated without knowledge of those performing queries. Efforts to facilitate accurate queries are ongoing.

### BRIEF DESCRIPTION OF THE DRAWINGS

For a detailed description of exemplary embodiments of the invention, reference will now be made to the accompanying drawings in which:

FIG. 1 shows a system layer architecture in accordance with an embodiment of the disclosure;

FIG. 2 shows a computer system in accordance with an embodiment of the disclosure;

FIG. 3 shows translation logic in accordance with an embodiment of the disclosure;

FIG. 4 shows a translation process in accordance with an embodiment of the disclosure;

FIG. 5 shows a data structure for mapping to a relational database in accordance with an embodiment of the disclosure;

FIG. 6 shows a translation result of a query in accordance with an embodiment of the disclosure;

FIG. 7 shows a translation result of another query in accordance with an embodiment of the disclosure; and

FIG. 8 shows a translation result of yet another query in accordance with an embodiment of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments disclosed herein translate a specialized data query language (referred to herein as “DQL”) to a structured query language (SQL) query. DQL is a query language which queries object instances in a data model to provide a list of rows where each row contains a cell for each column, meta-data for each column is also provided. A cell contains a single value of a data type associated with its column. The rows are provided by a relational database when the SQL part of the translation result is executed. As described herein, DQL enables a user to express a query for objects, including object property criteria and object history criteria. The searchable objects and their properties and history are stored in a relational database in a form where direct query using structured query language (SQL) is not as succinct, readable and maintainable as DQL.

Organized data (e.g., objects, their properties and their history) in a relational database is definable by a mapping between a data model and database schema. To query the underlying relational database, users need to know the mapping and need to perform a translation from the data model to the underlying relational database. Embodiments disclosed herein allow users to express queries in a language which is closer to the data model than to the relational model of the database. The disclosed query technique is more succinct and readable for those who know the data model.

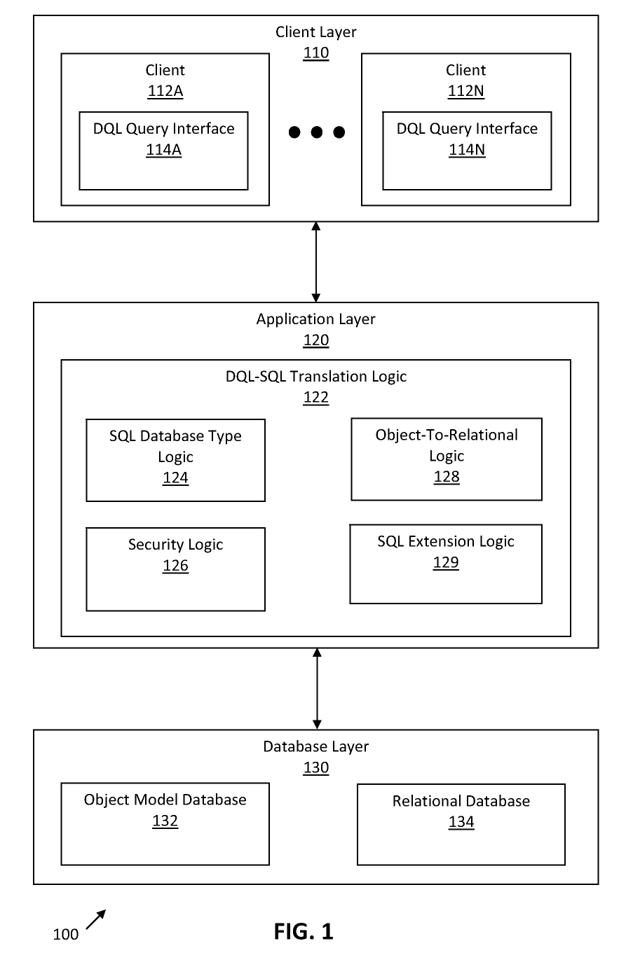

FIG. 1 shows a system layer architecture 100 in accordance with an embodiment of the disclosure. As shown, the system 100 comprises a client layer 110 and a database layer 130 in communication with an application layer 120. The client layer 110 comprises clients 112A-112N that are able to perform queries to the database layer 130 via the application layer 120. Each of the clients 112A-112N comprises a respective DQL query interface 114A-114N. In at least some embodiments, the DQL query interface 114A-114N corresponds to a Web browser or other interface for network-based communications. Alternatively, the DQL query interface 114A-114N may correspond to an application window that enables query submissions across local communication architectures (e.g., if the client layer 110 and the application layer 120 are implemented on the same computer). Regardless of whether the client layer 110 and the application layer 120 are local or remote to each other, the DQL query interface 114A-114N enables a user to submit DQL queries to the application layer 120.

In accordance with at least some embodiments, the object model database 132 of the database layer 130 stores a data model referred to herein as SDM. However, DQL may be used with different object models and is not limited to the SDM model. The SDM model describes object types. Each object type can contain one or more properties. Each property can be specified as a single value property or as a property holding multiple values. The value type of each property can be simple (e.g. text, integer, date, etc.), complex (address, taxonomy, etc.) or relational. A relational property value refers to an instance of another object. Further, an object type may inherit properties from a single other object type, forming hierarchies without circles and diamonds (multiple inheritance is not allowed). Object instances hold the data modeled by the object type. Such object instances are stored in the relational database 134 to be queried.

As shown, the application layer 120 comprises DQL-SQL translation logic 122. The DQL-SQL translation logic 122 generates an SQL query based on an input DQL query from one of the clients 112A-112N. In at least some embodiments, the DQL-SQL translation logic 122 generates the SQL query using SQL database type logic 124, security logic 126, object-to-relational logic 128, and SQL extension logic 129. The SQL database type logic 124 identifies the type of underlying relational database (e.g., relational database 134 of database layer 130) to be queried. For example, in some embodiments, the SQL database type logic 124 stores an updatable list of known relational database types based on criteria such as vendor, supported features, etc. The SQL database type logic 124 is also configured to receive a control signal that indicates the particular relational database type to be searched.

As part of the translation process, the DQL-SQL translation logic 122 utilizes security logic 126 to regulate access to data in the relational database 134. The security logic 126 may operate, for example, based on user access right information provided by meta-data in the relational database 134. The meta-data of the object instances in the relational database 134 includes access control lists and owner information as to enable different access rights to different users of the system without any cooperation from the user writing a query. The translation process of the application layer 120 enforces these access rights by including conditions or sub-queries that limit the access in the translated query in SQL. If the users of the system 100 would be allowed to enter SQL directly, the access rights could be breached. Other systems could modify user-provided SQL to include access rights, but such techniques are complex and error-prone due to: various SQL language extensions, differences in different databases, and the low level nature of SQL.

The object-to-relational logic 128 maps object types, object property information, and object history information in the object model database 132 to data in the relational database 134. In at least some embodiments, information stored in the object model database 132 comprises a list of all property names along with the property type. Examples of simple property types include: a string, a number, or a date. An example of a complex type includes an address with multiple fields (e.g., name, city, street). The complex type may be referred to as a structural type. The object model database 132 also may store relational values that include a relation to a specific object type or abstract object type. The object model database 132 also may stores a list of object types that describe for each object type: 1) which object type is parent of the object type in the hierarchy; and 2) a list of properties of an object type along with cardinality (single or multiple). The object model database 132 also stores information about how the objects are mapped into tables of the relational database 134. In other words, the way model data is stored in a relational database (the mapping) may be different for various relational database vendors. Also, various relational databases have differences in their query language. The system 100 allows the expression of a query in the same way for each of these different relational databases and their mappings.

The SQL extension logic 129 enables various query features. For example, adding historic information to data often complicates queries in classic relational databases. A query usually needs to be constructed in a way that returns only the latest revisions of the data. In at least some embodiments, the SQL extension logic 129 provides a way to query historic data based on time or based on historic life-cycle states (e.g., only the last approved revision of objects is returned). These modes are activated using modifiers which are specified in a list next to some selected object types in the query. By default, only the latest instances of data are queried. Thus, DQL queries have the advantage of succinctness in the common case of a query for latest object revisions (no modifier). Further, DQL queries are also very succinct when a modifier is specified compared to a corresponding query expressed in SQL, where a complex set of conditions or sub-queries is needed for revision selection.

The SQL extension logic 129 also enables the expression of some common computations derived from object properties and other model data or meta-data as if the results of these computations where actual properties of the objects. These computed properties allow isolation of the sources for their computation so they are accessed only in defined ways. There are also computed object instances, where the several object instances are computed from other data sources.

The SQL extension logic 129 also enables inversion of property inheritance. To clarify, some reports for which query languages are used need to query several properties across various object types. Some of these object types may omit some of the properties. Such a query can be constructed in SQL by merging the results for each object type using the “union” operator. Such a query is large and fragile with respect to model changes. The SQL extension logic 129 allows the grouping of objects by their hierarchy and performs queries using a parent object type or the root of the object type hierarchy. Thus, handling of the omitted properties is automatic.

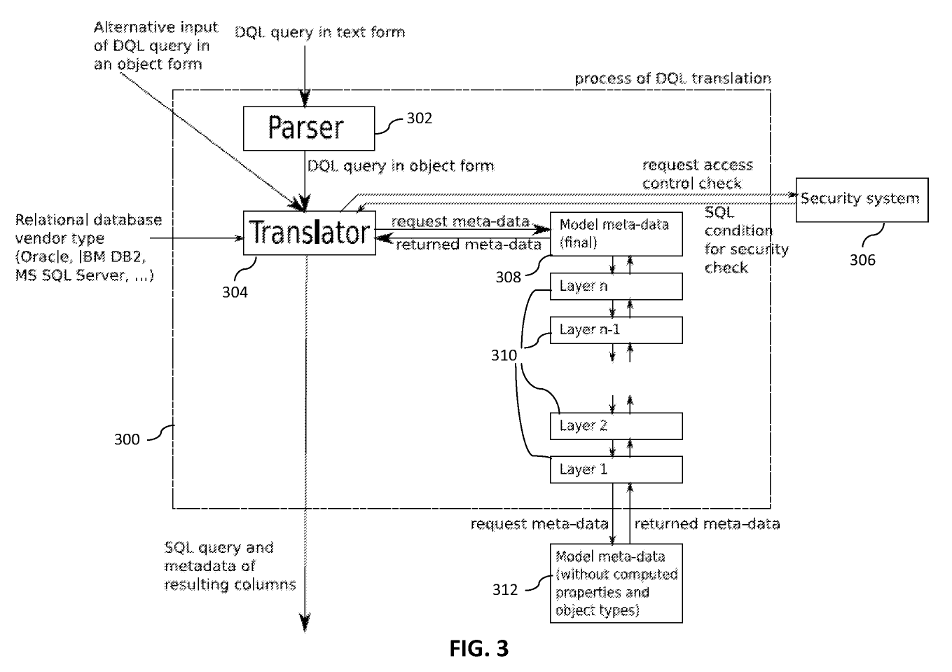

In operation, the application layer 120 is configured to receive an object form query from one of the database query interfaces 114A-114N, to translate the object form query to a structured query language (SQL) query, and to forward the SQL query to the relational database 134. The object form query may comprise an object, object property criteria, and object history criteria such as are stored by object model database 132. Upon receipt of the object form query, the application layer 120 limits a query based on a time window or data life-cycle specified by the object history criteria and, if no object history criteria is provided, the application layer 120 limits a query to only latest instances of data. The application layer 120 also enables expression of computations derived from the object property criteria to be treated as an object property, where the sources for the computations are isolated and accessed according to predefined rules. In other words, some properties or object types are not defined through object model database 132, but are defined using the SQL extension logic 129 (related to layers 310 described for FIG. 3).

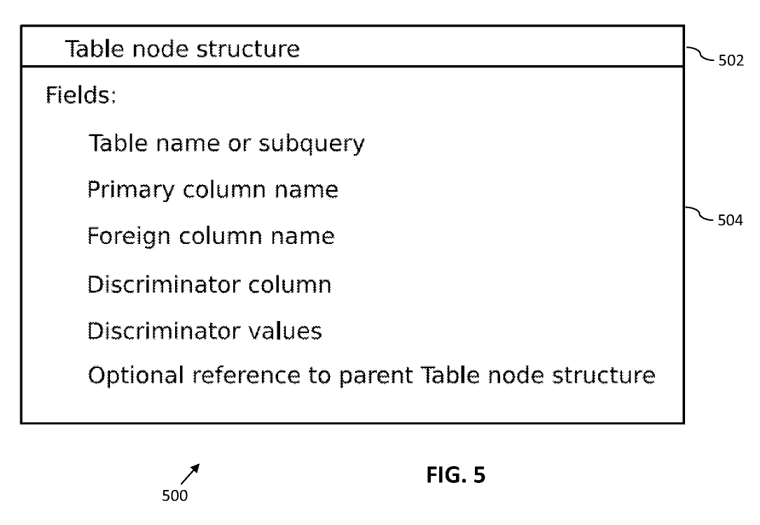

As an example, every object instance may have a computed property {_artifactTypeName}, which provides a human-readable name of the object type. This property is stored inside the object model database 132. At least some embodiments disclosed herein execute queries that return not just object instance properties but also the name of the object type. When the layer that defines the property is asked for the property mapping, a resulting structure (e.g., as in FIG. 5) is returned with first field containing the subquery: {(SELECT ry_resource.id, humanReadableName FROM ry_resource LEFT JOIN ry_artifactType ON ry_resource.fk_artifactType=ry_artifactType.id)}.

As another example, at least some embodiments disclosed herein provide a feature to assign a rating to any object instance (e.g., when an object instance represents a book, the rating might be 0-5 stars). Ratings are recorded in tables that reside in relational database 134. A rating layer of the SQL extension logic 129 may provide a computed property {_rating} on all object instances. When this rating layer is asked for a mapping of the rating property, the returned structure (e.g., as shown in FIG. 5) contains a subquery that computes the actual rating for all instances returned by a query.

Usage of SQL extension logic 129 (e.g., layers 310) as disclosed herein enables objects to have properties that use different (or even custom) mapping into the relational database 134, instead of default mapping of properties into the relational database 134. This feature enables: 1) defining a more effective mapping for specific data in terms of update/query performance and/or storage requirements; and 2) linking object instances with information from a different data source (e.g., a completely different program storing information about the instances in the same relational database 134). However, this different data source is not required to implement the disclosed object-relational mapping technique.

The application layer 120 also enforces different data access rights by designation of access conditions in the SQL query without input of security information in the object form query. As needed, the application layer 120 is able to provide different mappings to enable query compatibility for different relational database types without input of a relational database type in the object form query. Further, the application layer 120 enables query of properties across various object types, where some of the various object types omit at least some of the properties.

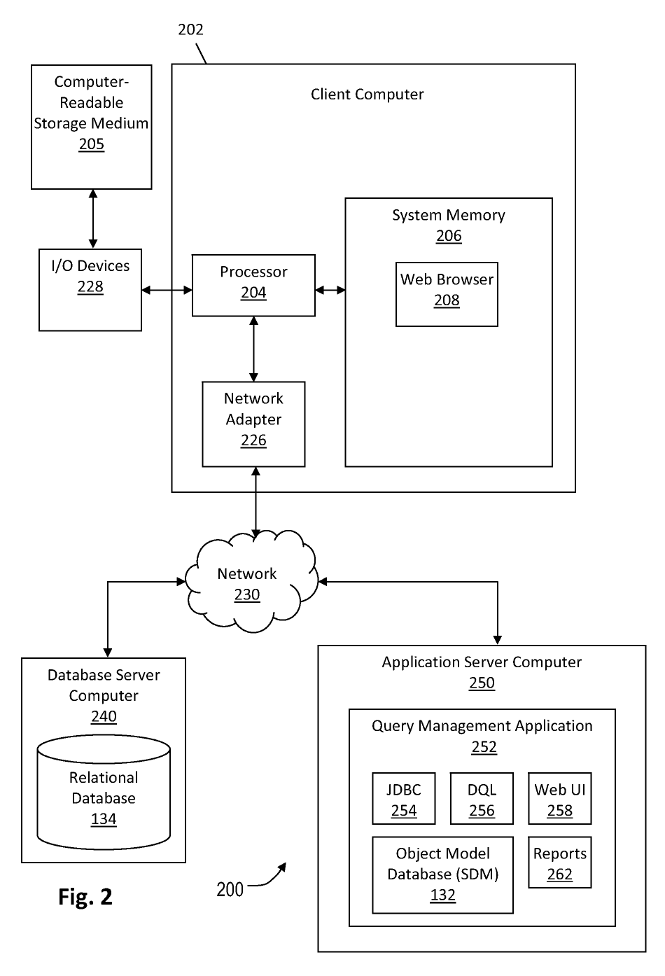

FIG. 2 shows a block diagram for a computer system 200 that may perform database querying as disclosed herein. As shown, the computer system 200 comprises a client computer 202, an application server computer 250 and a database server computer 240 in communication via a network 230. In alternative embodiments, the operations of the client computer 202, the application server computer 250, and the database server computer 240 are combined on one computer, two computers, or more computers as is shown for FIG. 3. In some embodiments, for example, the client computer operations and the application server computer operations may be combined on a single computer. Additionally or alternatively, the application server computer operations and the database server computer operations may be combined on a single computer.

In FIG. 2, the database server computer 240 comprises the relational database 134. Examples of the relational database 134 include, but are not limited to, Oracle DBs, IBM DB2s, and Microsoft SQL servers. The information in the relational database 134 includes object instances with historical data, access rights attached to object instances, lifecycle information, and other data unrelated to DQL.

The application server computer 250 comprises a query management application 252. In some embodiments, the query management application 252 corresponds to a version of HP's “SOA Systinet” software. As shown, the query management application 252 comprises a Java Database Connectivity (JDBC) module 254 to access a database with a Java application. The JDBC module 254 comprises: 1) a common part which may be bundled with Java runtime environment software; and 2) a driver part supplied by relational database vendors. To access the relational database 134, a proprietary protocol is implemented by the driver part of the JDBC module 254. With the database server computer 240 coupled to the application server computer 250 via a network 230 as in FIG. 2, communications between server computers 240 and 250 also may be based on TCP/IP.

As shown, the query management application 252 also comprises a DQL module 256 that corresponds to the DQL-SQL translation logic 122 described in FIG. 1. The query management application 252 also comprises or has access to the object model database (SDM) 132, which stores object definitions identified by name, object properties for each named object, object type information, and parent object definitions (used for inheritance of properties).

The query management application 252 also comprises a reports module 262 configured to generate reports regarding query results or other requested information. The queries described herein are submitted to the query management application 252 based on a Web user interface (UI) module 258 that enables communication with a Web browser 208 executed by the client computer 202. In at least some embodiments, communications between the Web UI module 258 of the query management application 252 and the Web browser 208 are based on a HTTP protocol (over TCP/IP) and/or HTML content. For example, DQL queries may appear in report definitions for reports that use DQL.

As shown in FIG. 2, the client computer comprises a processor 204 (or processors) coupled to system memory 206. Some embodiments of the client computer 202 also include a network adapter 226 and I/O devices 228 coupled to the processor 104. The client computer 202 is representative of a desktop computer, a server computer, a notebook computer, a handheld computer, or a smart phone, etc., configured to communicate with server computers 240 and 250 via the network 230.

The processor 204 is configured to execute instructions read from the system memory 206. The processor 204 may be, for example, a general-purpose processor, a digital signal processor, a microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The system memory 206 corresponds to random access memory (RAM), which stores programs and/or data structures during runtime of the client computer 202. For example, during runtime of the client computer 202, the system memory 206 may store Web browser 208 for execution by the processor 204. The system 200 also may comprise a computer-readable storage medium 205, which corresponds to any combination of non-volatile memories such as semiconductor memory (e.g., flash memory), magnetic storage (e.g., a hard drive, tape drive, etc.), optical storage (e.g., compact disc or digital versatile disc), etc. The computer-readable storage medium 205 couples to I/O devices 228 in communication with the processor 204 for transferring data/code from the computer-readable storage medium 205 to the client computer 202. In some embodiments, the computer-readable storage medium 205 is locally coupled to I/O devices 228 that comprise one or more interfaces (e.g., drives, ports, etc.) to enable data to be transferred from the computer-readable storage medium 205 to the client computer 202 or the application server computer 250. Alternatively, the computer-readable storage medium 205 is part of a remote system (e.g., a server) from which data/code may be downloaded to the client computer 202 via I/O devices such as I/O devices 228. In such case, the I/O devices 228 may comprise networking components (e.g., network adapter 226). Regardless of whether the computer-readable storage medium 205 is local or remote to the client computer 202, the code and/or data structures stored in the computer-readable storage medium 205 are loaded into system memory 206 for execution by the processor 204.

The I/O devices 228 also may comprise various devices employed by a user to interact with the processor 204 based on programming executed thereby. Exemplary I/O devices 228 include video display devices, such as liquid crystal, cathode ray, plasma, organic light emitting diode, vacuum fluorescent, electroluminescent, electronic paper or other appropriate display panels for providing information to the user. Such devices may be coupled to the processor 204 via a graphics adapter. Keyboards, touchscreens, and pointing devices (e.g., a mouse, trackball, light pen, etc.) are examples of devices includable in the I/O devices 228 for providing user input to the processor 204 and may be coupled to the processor 204 by various wired or wireless communications subsystems, such as Universal Serial Bus (USB) or Bluetooth interfaces.

A network adapter 226 may couple to the processor 204 to allow the processor 204 to communicate with server computers 240 and/or 250 via the network 230. For example, the network adapter 226 may enable the client computer 202 to acquire content (e.g., query results, meta-data, reports, etc.) from the application server computer 250. More specifically, the application server computer 250 may receive queries from the client computer 202. In response, the application server computer 250 may access the object model database 132 and the relational database 134 described for FIG. 1 to return query results or related reports to the client computer 202. The network adapter 226 may allow connection to a wired or wireless network, for example, in accordance with protocols such as IEEE 802.11, IEEE 802.3, Ethernet, cellular technologies, etc. The network 230 may comprise any available computer networking arrangement, for example, a local area network (“LAN”), a wide area network (“WAN”), a metropolitan area network (“MAN”), the internet, etc. Further, the network 230 may comprise any of a variety of networking technologies, for example, wired, wireless, or optical techniques may be employed. Accordingly, the server computers 240 and 250 are not restricted to any particular location or proximity to the client computer 202.

The discussion of components (e.g., processor 204, system memory 206, network adapter 226, I/O device 228, and computer-readable storage medium 205) related to the client computer 202 may be extended to the server computers 240 and/or 250. As an example, the query management application 252 may have been retrieved from a computer-readable storage medium, such as computer-readable storage medium 205, and stored in a system memory of application server computer 250 for execution by a processor.

In accordance with at least some embodiments, the computing system 200 enables DQL queries as described herein based on operations of the query management application 252. For example, the query management application 252 may perform the functions described for the SQL database type logic 124, the security logic 126, the object-to-relational logic 128, and the SQL extension logic 129 described for FIG. 1.

In at least some embodiments, the query management application 252, when executed, causes a processor (e.g., processor 204) to receive an object form query, translate the object form query to a structured query language (SQL) query, and forward the SQL query to a relational database. The translation is based on mapping translation contexts from a meta-data model to one of a plurality of relational database types. The query management application 252 also may cause the processor to generate column meta-data related to the SQL query based on the mapped translation contexts. The query management application 252 also may cause the processor to treat computations, derived from object property criteria in the object form query, as object properties. The query management application 252 also may cause the processor to invert property inheritance of an object in the object form query.

FIG. 3 shows translation logic 300 in accordance with an embodiment of the disclosure. As shown, the translation logic 300 comprises a parser 302 that receives a DQL query in text form and outputs a DQL query in object form. In other words, the input for a DQL query may be in either text form or object form corresponding to an abstract syntax tree. The DQL query in object form is provided to a translator 304, which outputs a SQL query and metadata of resulting columns. More specifically, the output is in the text form of SQL and model-level information about columns that will be provided when the SQL query is executed. The output of the translator 304 is designed for use with a textual or graphical user interface that is able to render the result of execution of the SQL query formatted according to the received meta-data from model meta-data 312. The model meta-data 312 may correspond to the object model database 132 of FIG. 1.

The translation process performed by the translator 304 is based on receipt of relational database vendor type information. The translator 304 also communicates with a security system 306 to request an access control check 306. In response, the security system 306 returns SQL conditions for the security check to the translator 304. The translator 304 also communicates with model meta-data 308, which comprises computed properties and object types. The model meta-data 308 is built by passing data from model meta-data 312, which does not have computed properties and object types related to layers 1-N 310, which enable the mapping and SQL extension features described herein. In other words, the model of the data and mapping is provided and several layers can add, change, or remove properties or object types from the model. Each layer 310 has an interface that allows for querying meta-data and the mapping of specific property or object types. In at least some embodiments, this meta-data includes: an enumeration of object types, an enumeration of properties for each particular object type, and a mapping to a relational database for each property.

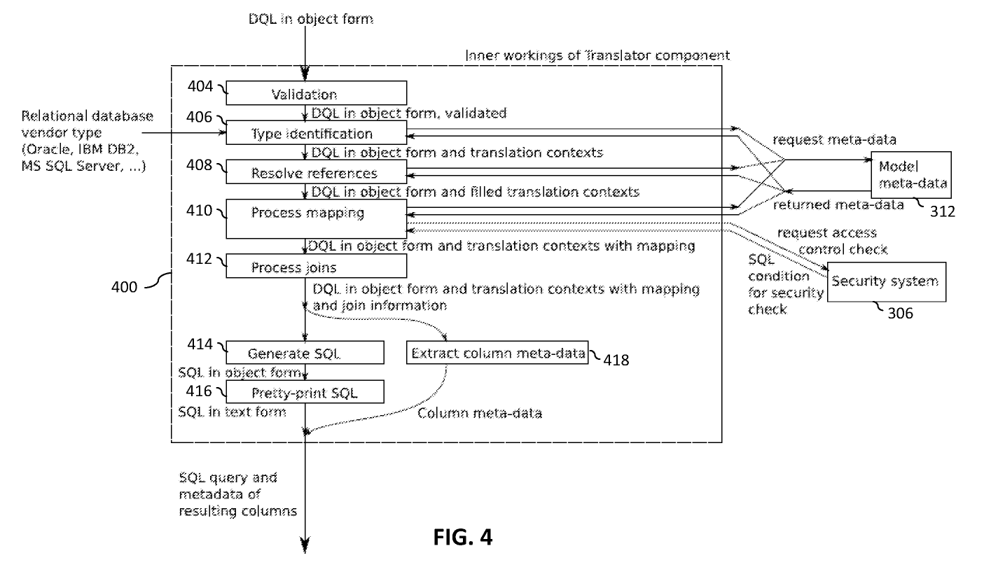

FIG. 4 shows a translation process 400 in accordance with an embodiment of the disclosure. As shown, the translation process 400 comprises a validation block 404 that receives DQL in object form and outputs validated DQL in object form to a type identification block 406. The type identification block 406 receives relational database type information and communicates with model meta-data 312 to provide translation contexts based on the relational database type. A resolve references block 408 receives the DQL in object form and communicates with the model meta-data 312 to fill the translation contexts. With the DQL in object form and the filled translation contexts, a process mapping block 410 provides mapping for the translation contexts. The mapping provided by the process mapping block 410 is based, in part, on communication with the security system 306 that provides SQL conditions in response to an access control check requested by the process mapping block 310.

The output of the process mapping block 310 is received by a process joins block 312, which adds join information to the DQL in object form and the mapped translation contexts. The mapping between the data model and relational model is described by mapping structures which are provided by the model meta-data 312. The core of these mapping structures is a description of how to connect several tables or sub-queries by joining use of the foreign keys for one table to a primary key of other mapping structures. Mapping structures also describe how to discriminate which rows are useful and which are not. Several such mapping structures are connected in the form of a parent-child relationship. The relationship allows for the mapping of inheritance in the object model to relational model.

At generate SQL block 414, SQL is generated in object form based on the output for the process joins block 412. The SQL in object form is then converted into SQL in text form by a pretty-print SQL block 416. As shown, an extract column meta-data block 418 also receives the output of the process joins block 412 and outputs column meta-data, which is combined with the SQL in text form.

FIG. 5 shows a data structure 500 for mapping to a relational database in accordance with an embodiment of the disclosure. As shown, the data structure 500 is referred to as a table node structure 502 with a plurality of fields 504. The fields 504 may be, for example, a table name or sub-query, a primary column name, a foreign column name, a discriminator column, discriminator values and/or an optional reference to a parent table node structure. The data structure 500 corresponds to a mapping that flows between the translator 304, the layers 310, and the model meta-data 312 of FIG. 3, The layers 310 are used to change mappings to introduce computed properties and object types.

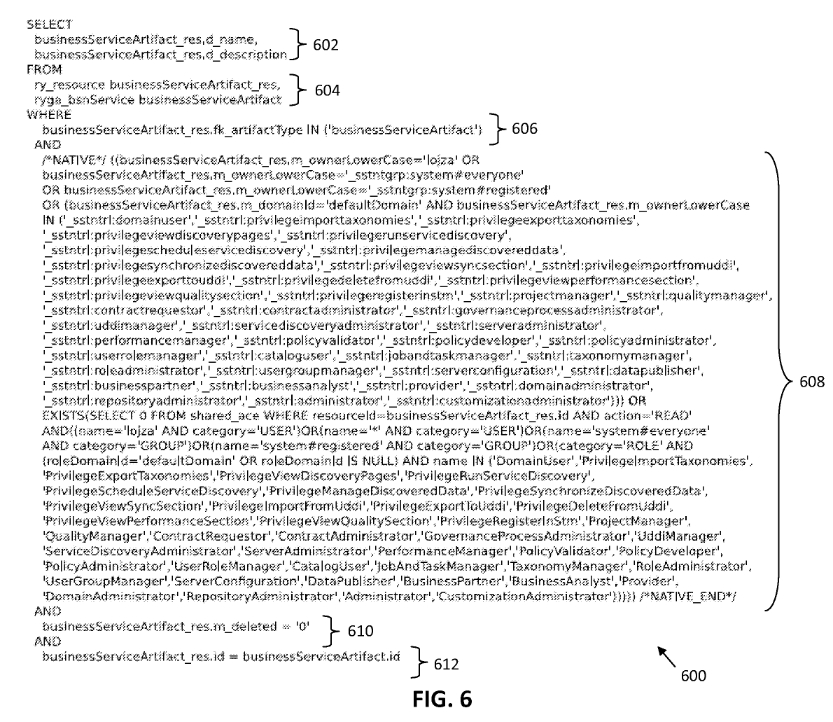

FIG. 6 shows a translation result 600 of a query in accordance with an embodiment of the disclosure. The translation result 600 is for a DQL query {select name, description from businessServiceArtifact} that selects the name and description of each object instance of an object type called “businessServiceArtifact.” This query is translated by a DQL translator (e.g., translator 304) to an SQL query and column meta-data.

As shown, the translation result 600 comprises sections 602, 604, 606, 608, 610 and 612. Section 602 shows selected columns. Section 604 shows tables to which object instances are mapped. Section 606 shows a restrictive condition which is a part of the specified mapping. The restrictive condition allows for the storage of properties common to the parent object type in a different table than where non-common properties are stored. The column name and compared value are retrieved from the model meta-data 312 described previously. Section 608 shows an access control checking condition for the particular user who invoked the query translation. Section 610 shows a history related check. In other words, the query system disclosed herein is able to track the history of object instances even after they have been deleted. By default, a query will only retrieve the latest versions of object instances that were not deleted. Section 612 shows a binding condition that joins source tables. The binding condition is based on model meta-data. The DQL query in this example is more succinct than the query in SQL form (for the particular object to relational database mapping).

A change in mapping which describes how object type instances are stored in a relational database is often needed due to performance or new product features. In accordance with at least some embodiments, DQL (being at higher level than SQL) can often be kept unchanged when such changes occurs. The only condition is that the model meta-data 312 provides updated mapping information. Mappings can also be different for different relational database vendors so that the schema is optimized for a particular database. Again, the model meta-data 312 will need to provide correct mapping information. Different relational databases differ in ways to achieve the same functionality. DQL provides a unified way to hide these incompatibilities between databases.

As an example, Oracle databases and IBM DB2 databases use the ∥ operator to denote string concatenation while Microsoft SQL uses the +operator for this. The DQL translation system disclosed herein hides these incompatibilities by using the one operator only and translating it correctly for relational databases that use the other operator (e.g., + operators are translated to ∥ operators). As another example, Oracle databases and IBM DB2 databases use LN as a name for a logarithm function while Microsoft SQL uses name LOG. The DQL translation system disclosed herein uses one notation and correctly translates to all vendor specific functions (e.g., LOG references are translated to LN references).

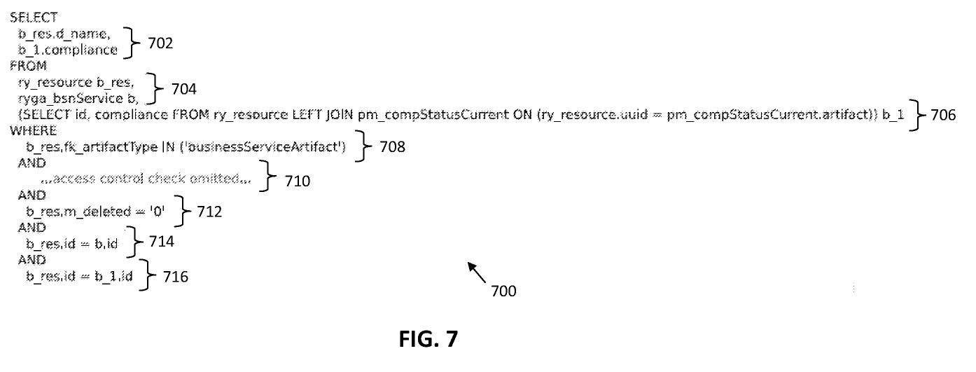

FIG. 7 shows a translation result 700 of another query in accordance with an embodiment of the disclosure. The translation result 700 is for a DQL query {select b.name, b._complianceStatus from businessServiceArtifact}. As shown, the translation result 700 comprises sections 702, 704, 706, 708, 710, 712, 714 and 716. Section 702 shows selected columns. Section 704 shows tables to which object instances are mapped. Section 706 shows a translation of computed property _complianceStatus. Section 708 shows a restrictive condition which is a part of the specified mapping similar to section 606 of translation result 600. Section 710 shows an access control check (omitted for brevity) similar to section 608 of translation result 600. Sections 712, 714 and 716 show a history related check similar to sections 610 and 612 of translation result 600.

In at some embodiments, access control checks are included in the SQL produced by DQL translation. An exemplary access control check is shown in section 608 of translation result 600. The check is specific for a particular user who invoked the translation of the DQL query. If such checks are needed in a system without DQL, the cooperation of the user who writes the query would be needed.

The DQL query technique disclosed herein permits access to historic revisions in a very concise way. There are several modifiers that affect which revisions are retrieved. By default, the latest revisions are retrieved. Also, there is an option to retrieve all stored revisions by specifying the all_rev modifier. Another example is the modifier last_approved_revision defined in for the disclosed DQL query technique to retrieve the last revision that is marked as approved in the object instance meta-data.

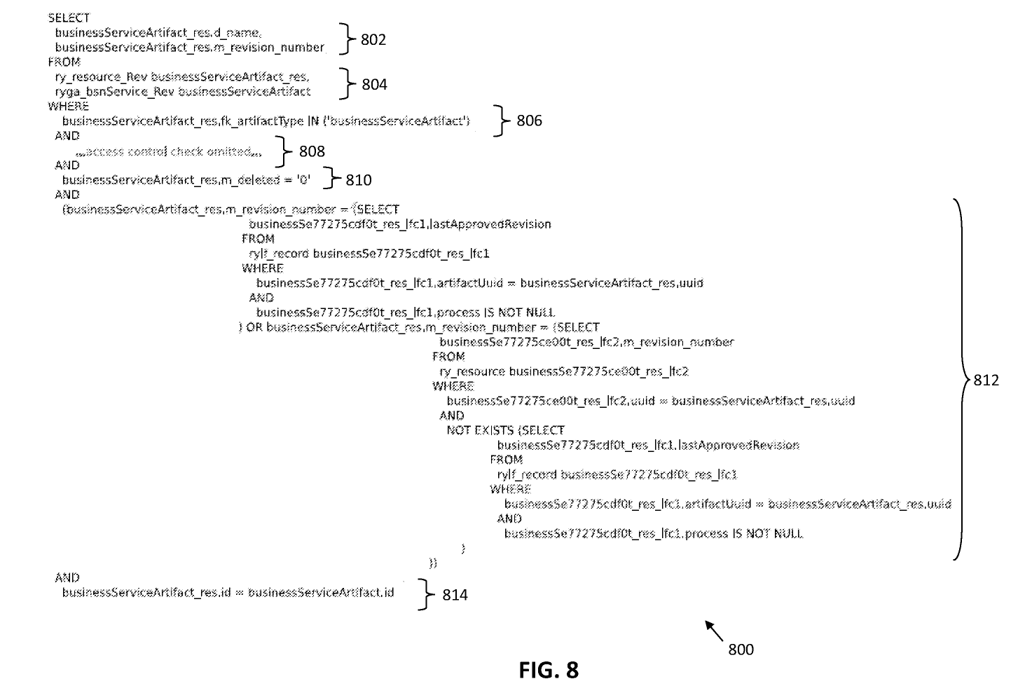

FIG. 8 shows a translation result 800 of yet another query in accordance with an embodiment of the disclosure. The translation result 800 is for a DQL query {SELECT name, _revision FROM businessServiceArtifact (last_approved_revision)}. As shown, the translation result 800 comprises sections 802, 804, 806, 808, 810, 812, and 814. Section 802 shows selected columns. Section 804 shows tables to which object instances are mapped. For the translation result 800, these tables hold all revisions unlike the tables shown for a query with no modifier. Section 806 shows a restrictive condition which is a part of the specified mapping similar to section 606 of translation result 600. Section 808 shows an access control check (omitted for brevity) similar to section 608 of translation result 600. Section 810 shows a condition to exclude deleted revisions. Section 812 shows a complex sub-query that identifies which revision is the latest approved revision of the object instance. Section 814 shows a binding condition similar to section 612 of translation result 600. It can be seen in FIG. 8 that the DQL query {SELECT name, _revision FROM businessServiceArtifact (last_approved_revision)} is much more concise than the equivalent SQL query (the translation result 800).

In the object model, particularly in SDM, it is common that properties defined in a parent object type are automatically available to a child object type. The child object type can add new properties to the properties defined by its parents. Inversion of property inheritance allows referencing of properties defined only to a child through its parents. When a parent object type is referred to, all its non-abstract children are retrieved. If a child does not have a particular or given property defined, a null value is provided instead.

As an example, consider the DQL query {select prop1, prop2, prop3 from myparent}. In this example, object type {myparent} has property {prop1} defined. This object type is abstract meaning that no object instances are possible. Further, the object type {mychild1} has property {prop2} defined and {prop1} is inherited from {myparent}. Further, object type {mychild2} has property {prop3} defined and {prop1} is inherited from {myparent}. Further, object type {mychild3} has both {prop2} and {prop3} properties defined, and {prop1} is inherited from {myparent}. Now the DQL query above (i.e., {select prop1, prop2, prop3 from myparent}) has same meaning as the following DQL query: {select prop1, prop2, NULL from mychild1 UNION ALL select prop1, NULL, prop3 from mychild2 UNION ALL select prop1, prop2, prop3 from mychild3}. This automatic behavior is useful for reporting data to user interfaces.

In at least some embodiments, query validation is performed on DQL queries. This prevents entering some invalid queries. The validation in a higher level language, DQL, allows for the expression of errors and warnings in a way that is more intelligible to the users of the system. If the query would be expressed in a relational query language (such as SQL) directly, such validation would be far more complex. For example, SQL differs among various relational databases that a system supports and the lower level of relational query language would not allow the system to produce equally useful error and warning messages.

Further, DQL query technique disclosed herein is more maintainable when the system is upgraded. System upgrades may change the way model data are stored in relational databases (the mapping), but DQL queries could stay same. In other words, the translation system can provide higher level meta-data related to selected values than those which are provided by relational databases. This is because there is some high-level meaning attached to object properties in the data model, while in relational databases the only meaning attached is a data type. This meta-data permits rendering results to users in a more accurate way. An ongoing problem with special languages for data queries is they are not easy to learn for most users. In contrast, DQL is easy to learn for those who know SQL already. While the semantics are different, the language keywords look familiar and the general concepts for constructing a query in SQL apply to the DQL also. Further, the layers 310 described herein are pluggable. Dynamic runtime binding permits plugging in a new layer just by including its implementation in the runtime environment and adding it to a list of layers.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a relational database;
an object model database separate from the relational database, wherein the object model database stores object type information and object property information related to object instances stored in the relational database; and
a first computer in communication with the relational database and the object model database, wherein the first computer is configured to receive an object form query from a database query interface, to translate the object form query to a structured query language (SQL) query using information from the object model database, and to forward the SQL query to the relational database,

2. The system of claim 1 wherein the object form query comprises an object, object property criteria, and object history criteria.

3. The system of claim 2 wherein the first computer is configured to limit a query based on a time window or data life-cycle specified by the object history criteria and, if no object history criteria is provided, the first computer is configured to limit a query to only latest instances of data.

4. The system of claim 2 wherein the first computer enables expression of computations derived from the object property criteria to be treated as an object property, and wherein sources for said computations are isolated and accessed according to predefined rules.

5. The system of claim 1 wherein the relational database comprises object instances with access control lists and owner information to provide different data access rights to different users, and wherein the first computer is configured to enforce the different data access rights by designation of access conditions in an SQL query without input of security information in the object form query.

6. The system of claim 1 wherein the first computer is configured to provide different mappings to enable query compatibility for different relational database types without input of a relational database type in the object form query.

7. The system of claim 1 wherein the first computer enables query of properties across various object types, where some of the various object types omit at least some of the properties.

8. The system of claim 1 wherein the object model database describes a plurality of object types with at least one property,
wherein each property can be specified as a single value property or a multiple value property, and
wherein each property value can be specified as simple value, a complex value, or a relational value.

9. The system of claim 8 wherein the object types selectively inherit properties of a single other object type to form hierarchies without multiple inheritances.

10. The system of claim 1 wherein the first computer stores the object model database and executes a query management application to translate the object form query to the SQL query, and wherein the first computer receives the object form query from a second computer via a Web browser interface executed by the second computed, and wherein the SQL query generated by the first computer is forwarded to a third computer that stores the relational database.

11. A query translation method, comprising:
receiving, by a processor, an object form query;
accessing, by the processor, a meta-data model to provide translation contexts for the object form query; and
mapping, by the processor, the translation contexts to one of a plurality of relational databases.

12. The query translation method of claim 11 further comprising generating a structured query language (SQL) query and related column meta-data based on the mapped translation contexts.

13. The query translation method of claim 11 further comprising filling the translation contexts using the meta-data model.

14. The query translation method of claim 11 further comprising performing a security check for the object form query.

15. The query translation method of claim 11 further comprising validating the object form query and receiving relational database type information, wherein said mapping the translation contexts is based on the received relational database type information.

16. A computer-readable storage medium having query translation code that, when executed, causes a processor to:
receive an object form query;
translate the object form query to a structured query language (SQL) query, wherein the translation is based on mapping translation contexts from a meta-data model to one of a plurality of relational database types; and
forward the SQL query to a relational database.

17. The computer-readable storage medium of claim 16 wherein the code, when executed, further causes the processor to generate column meta-data related to the SQL query based on the mapped translation contexts.

18. The computer-readable storage medium of claim 16 wherein the code, when executed, further causes the processor to limit the SQL query based on object history criteria specified in the object form query.

19. The computer-readable storage medium of claim 16 wherein the code, when executed, further causes the processor to treat computations, derived from object property criteria in the object form query, as object properties.

20. The computer-readable storage medium of claim 16 wherein the code, when executed, further causes the processor to invert property inheritance of an object in the object form query.
